(19) United States
(12) Patent Application Publication
(10) Pub. No.: US 2016/0127765 A1
(43) Pub. Date: May 5, 2016

(54) PAUSING PLAYBACK OF MEDIA CONTENT BASED ON USER PRESENCE

(71) Applicant: EchoStar UK Holdings Limited, Keighley (GB)

(72) Inventor: David Robinson, Keighley (GB)

(21) Appl. No.: 14/529,989

(22) Filed: Oct. 31, 2014

(51) Int. Cl. H04N 21/433; H04N 21/41; H04N 21/442

(52) U.S. Cl. CPC H04N 21/4333; H04N 21/44218; H04N 21/4334; H04N 21/4131

(57) ABSTRACT

Systems and methods for managing presentation of media content based on a viewer status. A system may include a television receiver that manages output of the media content for presentation through a display device based on a status data detected by a status sensor. The status data is indicative of a presence of a viewer in an environment containing the display device.

### BACKGROUND

Television viewers often face limited convenience and flexibility in regard to the presentation of media content during viewing. For example, television viewers often become distracted in the middle of a television show, leave the show, and return at a later point to continue watching. Typically, the show continues playing while the viewer is absent and the viewer misses a portion of it. In that case, the viewer must resume watching the rest of the show without seeing the missed portion. This may take away from viewer experience and diminish viewer satisfaction. In other cases, the viewer may forget or be unable to pause the show or movie before leaving, which results in similar inconveniences. This disclosure is intended to address these concerns and to provide related advantages.

### SUMMARY

In one embodiment, a method for pausing output of a media content based on a viewer status is provided. The method may include outputting, by a television receiver, the media content for presentation via a display device. The method may further include receiving, by the television receiver, status data detected by a status sensor, wherein the status data is indicative of a presence of a viewer in an environment containing the display device. Still, the method may include determining, by the television receiver, that the viewer is present in the environment based on the status data. The method includes, in response to determining that the viewer is present in the environment, determining, by the television receiver, that the viewer has left the environment based on the status data detected by the status sensor. In some aspects, the method may further include, in response to determining that the viewer has left the environment, pausing, by the television receiver, output of the media content via the display device.

Various embodiments of the method may include one or more of the following features. The method may include determining, by the television receiver, that the viewer has returned to the environment, and after determining that the viewer has returned, resuming output, by the television receiver, of the media content via the display device. The method may include determining, by the television receiver after determining that the viewer has left the environment, that the media content includes broadcast television media content, and recording, by the television receiver after determining that the media content includes broadcast television media content, the media content. In another aspect, the method may include pausing recording, by the television receiver, during a commercial event that is included in the media content. The method may include determining, by the television receiver after initiating recording, that the viewer has returned to the environment based on the status data detected by the status sensor; and after determining that the viewer has returned to the environment, outputting, by the television receiver, the recorded media content for presentation via the display device. Still, the method may include outputting, by the television receiver after pausing output of the media content, a message indicating a reason for pausing the output, wherein the message comprises at least one of a textual notification, a sound notification, and a graphical notification presented via the display device.

In another aspect, the method may include presenting, by the television receiver, a user interface menu that includes at least one of resuming output of the media content after pausing the media content and setting a duration of time for recording the media content. The method may include initiating, by the television receiver after pausing output of the media content, a sleep mode that causes the display device to turn off or enter standby. The method may include sending, by the television receiver after determining that the viewer has left the environment containing the display device, a first operational setting to a smart device in communication with the television receiver. Still, the method may include sending, by the television receiver after determining that the viewer has returned to the environment containing the display device, a second operational setting to the smart device, wherein the second operational setting is different than the first operational setting. In a further aspect, the smart device is a lighting device located in the environment containing the display device. The first operational setting includes at least one of powering down or off of the lighting device and the second operational setting includes at least one of powering up or resuming an original state of the lighting device. The method may further include receiving, by the television receiver, status data detected by the status sensor that is indicative of a presence of a mobile device in the environment containing the display device and analyzing, by the television receiver, the status data that is indicative of the presence of the mobile device to determine the presence of the viewer in the environment containing the display device.

In another embodiment, a television receiver for managing presentation of media content based on a viewer status is provided. The television receiver may include one or more processors and a memory communicatively coupled with and readable by the one or more processors. The memory may have stored therein processor-readable instructions that, when executed by the one or more processors, cause the one or more processors to output the media content for presentation via a display device and receive status data detected by a status sensor, wherein the status data is indicative of a presence of a viewer in an environment containing the displace device. The memory may further have processor-readable instructions that cause the one or more processors to determine that the viewer is present in the environment based on the status data, and in response to determining that the viewer is present in the environment, determine that the viewer has left the environment based on the status data. Further, the memory may include processor-readable instructions that cause the one or more processors to, in response to determining that the viewer has left the environment, pause output of the media content via the display device.

Embodiments of such a device may include one or more of the following features. The memory may include processor-readable instructions stored therein that, when executed by the one or more processors, cause the one or more processors to determine that the viewer left the environment containing the display device during a commercial event included in the media content. The processor-readable instructions may include instructions that cause the one or more processors to, after determining that the viewer left the environment during the commercial event, continue output of the commercial event for presentation via the display device, detect an end of the commercial event before determining that the viewer has returned to the environment based on the status data detected by the status sensor, and in response to detecting the end of the commercial event, pause output of the media content. Further, the processor-readable instructions may cause the one or more processors to record the media content. In another aspect, the memory includes processor-readable instructions stored therein that, when executed by the one or more processors, cause the one or more processors to: determine that the viewer returned to the environment containing the display device and output the recorded media content for presentation via the display device.

In yet another embodiment, a method for pausing playback of a broadcast television media content based on a viewer status is provided. The method may include receiving, by a television receiver, an incoming stream of the broadcast television media content, wherein the broadcast television media content includes a programming event, outputting, by the television receiver, the broadcast television media content for presentation via a display device, and analyzing, by the television receiver, a first status data detected by a status sensor that senses a presence of a viewer in an environment containing the display device. The method may further include determining, by the television receiver, that the viewer is present in the environment based on the first status data. Further, the method may include, in response to determining that the viewer is present in the environment, determining, by the television receiver, that the viewer has left the environment based on a second status data detected by the status sensor. The method may include, in response to determining that the viewer has left the environment, pausing, by the television receiver, output of the programming event in the broadcast television media content, and in response to pausing output of the programming event, recording, by the television receiver, the incoming stream of the programming event in the broadcast television media content.

Embodiments of such a device may include one or more of the following features. The method may include, after determining that the viewer has returned to the environment based on a third status data detected by the status sensor, outputting, by the television receiver, the recorded programming event. The method may further include detecting, by the television receiver, a commercial event in the broadcast television media content and pausing, by the television receiver, recording of the incoming stream of the broadcast television media content until the commercial event has ended. In another aspect, the method may include outputting, by the television receiver, the commercial event for presentation via the display device, and after outputting the commercial event, detecting, by the television receiver, at least one of an end of the commercial event and a beginning of the programming event. Furthermore, the method may include, after detecting at least one of the end of the commercial event and the beginning of the programming event, pausing, by the television receiver, output of the programming event, and after pausing output of the programming event, recording, by the television receiver, the incoming stream of the programming event.

### BRIEF DESCRIPTION OF THE DRAWINGS

FIG. 1 shows a media content presentation system having a television receiver according to various embodiments of the present disclosure;

FIG. 2 shows the television receiver of FIG. 1;

FIG. 3 shows a method of the television receiver of FIG. 1;

FIG. 4 shows yet another method of the television receiver of FIG. 1;

FIG. 5 shows an example user interface provided for by the television receiver of FIG. 1; and

FIG. 6 shows a computing system related to the television receiver of FIG. 1.

### DETAILED DESCRIPTION

The present disclosure is directed to systems and methods for managing presentation of media content through a display device. More particularly, the disclosure provides systems and methods for pausing and/or recording the media content based on a user (herein referred to as a “viewer”) status. The viewer status is determined based on status data detected by a status sensor. The status data may indicate whether the viewer is present, absent, and/or busy in an environment containing the display device.

It is contemplated that the systems and methods described herein enhance the viewer's convenience and flexibility with viewing the media content. For example, if the viewer becomes distracted during the middle of a show and leaves the viewing environment, the viewer may return and pick up watching the show where he or she left off from, without having to manually pause and/or record the show. In some cases, the viewer may be unable to, or may forget to, pause and/or record the media content prior to leaving the environment. In that case, the viewer utilizing the systems and methods described herein may still resume presentation of the media content upon returning to the environment without having to worry about missed content. Furthermore, the device described herein may monitor the user's engagement with a TV program (e.g., walking out while it is on, surfing the web for unrelated content or related content on the user's tablet) and can add to metrics it collects about programs the user likes and dislikes. The device may detect that multiple users are present and allow such information to be collected and updated for each user. It is contemplated that the collected information may be used for making future programming recommendations, targeting advertisements, and the like.

In another aspect, the systems and methods described herein may provide advantages related to energy savings by detecting that the viewer is absent and instructing other device(s) in the presentation system and/or environment to change to a different setting. For instance, the systems and methods described herein may implement a screensaver mode on a display screen of the display device and/or signal a smart device to adjust operations according to the viewer's absence or presence, e.g. provide instructions to a lighting device within the viewing environment for dimming while the viewer is absent. Further advantages are discussed below in the succeeding paragraphs.

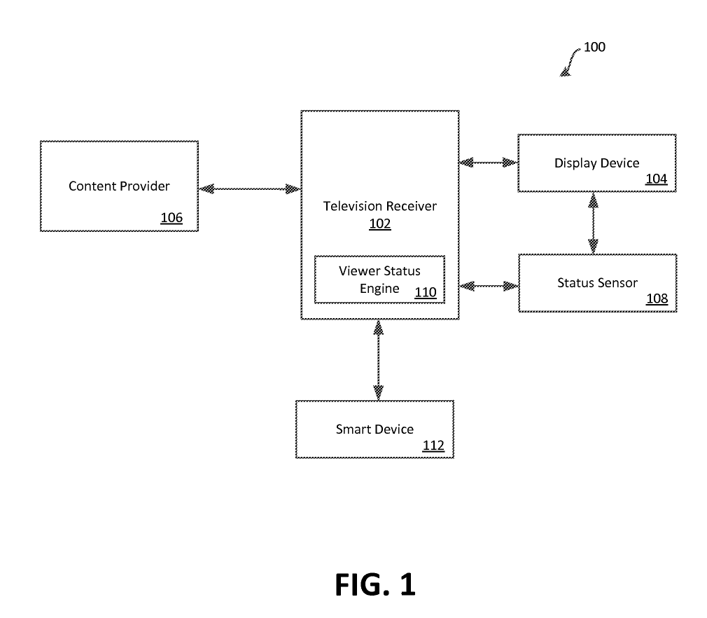

The systems and methods described herein may be implemented by any computing device, such as set-top-boxes, computers, tablets, notebooks, mobile devices, and other electronics that are capable of presenting media content. Merely by way of example, FIG. 1 illustrates one possible implementation of the present disclosure with a media content presentation system 100 having a television receiver 102. In one aspect, the term “television receiver” may refer to a set-top-box that is used to present media content, such as live broadcast television media content, on-demand content, DVDs, radio, audiobooks, and the like. The television receiver 102 may receive and send data or instructions to a display device 104, such as a television, computer, projector, tablet computer, or any other device capable of presenting the media content. In some cases, the media content is received by the television receiver 102 from a remotely-located service provider or content provider 106 linked to the television receiver 102 via a one or two-way communication link, such as a data network using satellites, terrestrial, internet, and the like.

As further shown in FIG. 1, the television receiver 102 may be in operative, one or two-way communication with a status sensor 108 that continuously, and/or when queried by the television receiver 102, detects status data and sends the detected status data to the television receiver 102. The status sensor 108 may include any of a variety of sensors that are capable of detecting a presence or condition of one or more viewers in the viewing environment. Such sensors may include an image sensor provided for by a camera, biometric sensor, heat sensor, infrared sensor, wireless signal sensor, sound sensor, scent sensor, light sensor, and so on. The status data detected by the status sensor 108 is sent to the television receiver 102, and more particularly, to a viewer status engine 110 of the television receiver 102. The viewer status engine 110 may analyze the status data and manage presentation of the media content based on the status data and/or analysis thereof. For instance, the viewer status engine 110 may pause output of the media content on the display device 104 when the status data indicates the viewer is absent from the environment and resume playing the media content when the status data detected at a later time indicates that the viewer has returned to the environment. Further, the viewer status engine 110 may provide various user interfaces for interaction and receiving input from the viewer. These functions are described in further detail in the succeeding paragraphs.

Still referring to FIG. 1, it is noted that the status sensor 108 may be incorporated in the television receiver 102, incorporated in the display device 104, or provided separately from the television receiver 102 and/or the display device 104. Similarly, it is contemplated that the television receiver 102 and the display device 104 may comprise an integrated device or separate devices. Furthermore, the status sensor 108 may be in operative communication, wireless or hardwired, with the display device 104 to send various signals and/or status data to or from the display device 104. In yet a further aspect, the television receiver 102 and/or other components of the system 100 may be connected to a smart device 112 through a smart home communication network, or any other device that may be represented by the smart device 112. It is noted that any of the components of the system 100 may be in wireless or hardwired communication, directly or indirectly, with any other components of the system 100 and that such connections are not limited to those shown in FIG. 1. Further, it is noted that any number of status sensors, display devices, television receivers, and smart devices may be provided for and communicatively connected together in the system 100.

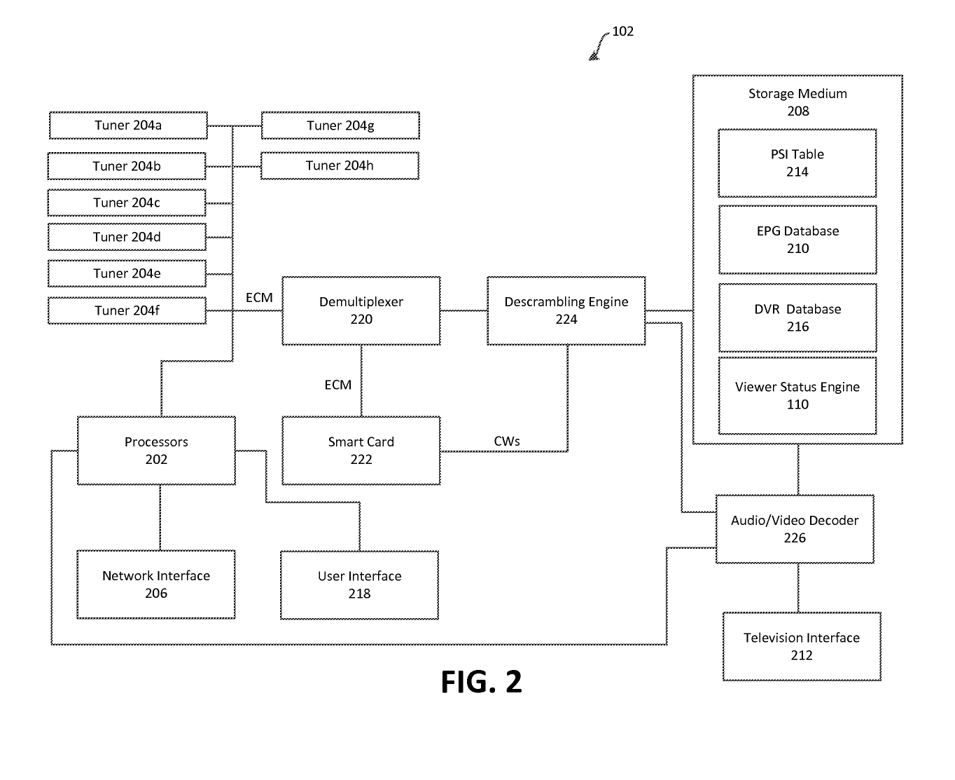

Turning now to FIG. 2, an example block diagram of various components in the television receiver 102 of FIG. 1 is shown in accordance with the disclosure. The television receiver 102 may include one or more processors 202, a plurality of tuners 204a-h, at least one network interface 206, at least one non-transitory computer-readable storage medium 208, at least one EPG database 210, at least one television interface 212, at least one PSI (Program Specific Information) table 214, at least one DVR database 216, at least one user interface 218, at least one demultiplexer 220, at least one smart card 222, at least one descrambling engine 224, and at least one decoder 226. In other embodiments, fewer or greater numbers of components may be present. Further, functionality of one or more components may be combined; for example, functions of the descrambling engine 224 may be performed by the processors 202. Still further, functionality of components may be distributed among additional components, and possibly additional systems such as, for example, in a cloud-computing implementation.

The processors 202 may include one or more specialized and/or general-purpose processors configured to perform processes such as tuning to a particular channel, accessing and displaying EPG information, and/or receiving and processing input from a user. For example, the processors 202 may include one or more processors dedicated to decoding video signals from a particular format, such as according to a particular MPEG (Motion Picture Experts Group) standard, for output and display on a television, and for performing or at least facilitating decryption or descrambling.

The tuners 204a-h may be used to tune to television channels, such as television channels transmitted via satellites (not shown). Each one of the tuners 204a-h may be capable of receiving and processing a single stream of data from a satellite transponder, or a cable RF channel, at a given time. As such, a single tuner may tune to a single transponder or, for a cable network, a single cable channel. Additionally, one tuner (e.g., tuner 204a) may be used to tune to a television channel on a first transponder stream for display using a television, while another tuner (e.g., tuner 204b) may be used to tune to a television channel on a second transponder for recording and viewing at some other time. If multiple television channels transmitted on the same transponder stream are desired, a particular tuner (e.g., tuner 204c) may be used to receive the signal containing the multiple television channels for presentation and/or recording of each of the respective multiple television channels, such as in a PTAT (Primetime Anytime) implementation for example. Although eight tuners are shown, the television receiver 102 may include more or fewer tuners (e.g., three tuners, twelve tuners, etc.), and the features of the disclosure may be implemented similarly and scale according to the number of tuners of the television receiver 102

The network interface 206 may be used to communicate via alternate communication channel(s) with a service provider. For example, the primary communication channel between the content provider 106 of FIG. 1 and the television receiver 102 may be via satellites, which may be unidirectional to the television receiver 102, and another communication channel between the content provider 106 and the television receiver 102, which may be bidirectional, may be via a network, such as various wireless and/or hardwired packet-based communication networks, including, for example, a WAN (Wide Area Network), a HAN (Home Area Network), a LAN (Local Area Network), a WLAN (Wireless Local Area Network), the Internet, a cellular network, a home automation network, or any other type of communication network configured such that data may be transferred between and among respective elements of the system 100. In general, various types of information may be transmitted and/or received via the network interface 206.

The storage medium 208 may represent a non-transitory computer-readable storage medium. The storage medium 208 may include memory and/or a hard drive. The storage medium 208 may be used to store information received from one or more satellites and/or information received via the network interface 206. For example, the storage medium 208 may store information related to the EPG database 210, the PSI table 214, and/or the DVR database 216, among other elements or features, such as the viewer status engine 110 mentioned above. Recorded television programs may be stored using the storage medium 208.

The EPG database 210 may store information related to television channels and the timing of programs appearing on such television channels. Information from the EPG database 210 may be used to inform users of what television channels or programs are available, popular and/or provide recommendations. Information from the EPG database 210 may be used to generate a visual interface displayed by a television that allows a user to browse and select television channels and/or television programs for viewing and/or recording. Information used to populate the EPG database 210 may be received via the network interface 206 and/or via satellites. For example, updates to the EPG database 210 may be received periodically via satellite. The EPG database 210 may serve as an interface for a user to control DVR functions of the television receiver 102, and/or to enable viewing and/or recording of multiple television channels simultaneously.

The decoder 226 may convert encoded video and audio into a format suitable for output to a display device. For instance, the decoder 226 may receive MPEG video and audio from the storage medium 208, or the descrambling engine 224, to be output to a television. MPEG video and audio from the storage medium 208 may have been recorded to the DVR database 216 as part of a previously-recorded television program. The decoder 226 may convert the MPEG video and audio into a format appropriate to be displayed by a television or other form of display device and audio into a format appropriate to be output from speakers, respectively. The decoder 226 may be a single hardware element capable of decoding a finite number of television channels at a given time, such as in a time-division arrangement. In the example embodiment, eight television channels may be decoded concurrently or simultaneously.

The television interface 212 outputs a signal to a television, or another form of display device, in a proper format for display of video and play back of audio. As such, the television interface 212 may output one or more television channels, stored television programming from the storage medium 208, such as television programs from the DVR database 216 and/or information from the EPG database 210 for example, to a television for presentation.

The PSI table 214 may store information used by the television receiver 102 to access various television channels. Information used to populate the PSI table 214 may be received via satellite, or cable, through the tuners 204a-h and/or may be received via the network interface 206 over the network from the content provider 106 shown in FIG. 1. Information present in the PSI table 214 may be periodically or at least intermittently updated. Information that may be present in the PSI table 214 may include: television channel numbers, satellite identifiers, frequency identifiers, transponder identifiers, ECM PIDs (Entitlement Control Message, Packet Identifier), one or more audio PIDs, and video PIDs. A second audio PID of a channel may correspond to a second audio program, such as in another language. In some embodiments, the PSI table 214 may be divided into a number of tables, such as a NIT (Network Information Table), a PAT (Program Association Table), a PMT (Program Management Table), etc.

DVR functionality of the PTR 210 may permit a television channel to be recorded for a period of time. The DVR database 216 may store timers that are used by the processors 202 to determine when a television channel should be tuned to and recorded to the DVR database 216 of storage medium 208. In some embodiments, a limited amount of space of the storage medium 208 may be devoted to the DVR database 216. Timers may be set by the content provider 106 and/or one or more viewers or users of the television receiver 102. DVR functionality of the television receiver 102 may be configured by a user to record particular television programs. The PSI table 214 may be used by the television receiver 102 to determine the satellite, transponder, ECM PID, audio PID, and video PID.

The user interface 218 may include a remote control, physically separate from television receiver 102, and/or one or more buttons on the television receiver 102 that allows a user to interact with the television receiver 102. The user interface 218 may be used to select a television channel for viewing, view information from the EPG database 210, and/or program a timer stored to the DVR database 216 wherein the timer may be used to control the DVR functionality of the television receiver 102.

Referring back to the tuners 204a-h, television channels received via satellite may contain at least some encrypted or scrambled data. Packets of audio and video may be scrambled to prevent unauthorized users, such as nonsubscribers, from receiving television programming without paying the content provider 106. When one of the tuners 204a-h is receiving data from a particular transponder of a satellite, the transponder stream may be a series of data packets corresponding to multiple television channels. Each data packet may contain a PID, which in combination with the PSI table 214, can be determined to be associated with a particular television channel. Particular data packets, referred to as ECMs may be periodically transmitted. ECMs may be encrypted; the television receiver 102 may use the smart card 222 to decrypt ECMs.

The smart card 222 may function as the CA (Controlled Access) which performs decryption of encryption data to obtain control words that are used to descramble video and/or audio of television channels. Decryption of an ECM may only be possible when the user, e.g., an individual who is associated with the television receiver 102, has authorization to access the particular television channel associated with the ECM. When an ECM is received by the demultiplexer 220 and the ECM is determined to correspond to a television channel being stored and/or displayed, the ECM may be provided to the smart card 222 for decryption.

When the smart card 222 receives an encrypted ECM from the demultiplexer 220, the smart card 222 may decrypt the ECM to obtain some number of control words. In some embodiments, from each ECM received by the smart card 222, two control words are obtained. In some embodiments, when the smart card 222 receives an ECM, it compares the ECM to the previously received ECM. If the two ECMs match, the second ECM is not decrypted because the same control words would be obtained. In other embodiments, each ECM received by the smart card 222 is decrypted; however, if a second ECM matches a first ECM, the outputted control words will match; thus, effectively, the second ECM does not affect the control words output by the smart card 222. When an ECM is received by the smart card 222, it may take a period of time for the ECM to be decrypted to obtain the control words. As such, a period of time, such as about 0.2-0.5 seconds, may elapse before the control words indicated by the ECM can be obtained. The smart card 222 may be permanently part of the television receiver 102 or may be configured to be inserted and removed from the television receiver 102.

The demultiplexer 220 may be configured to filter data packets based on PIDs. For example, if a transponder data stream includes multiple television channels, data packets corresponding to a television channel that are not desired to be stored or displayed by the user may be ignored by the demultiplexer 220. As such, only data packets corresponding to the one or more television channels desired to be stored and/or displayed may be passed to either the descrambling engine 224 or the smart card 222; other data packets may be ignored. For each channel, a stream of video packets, a stream of audio packets and/or a stream of ECM packets may be present, each stream identified by a PID. In some embodiments, a common ECM stream may be used for multiple television channels. Additional data packets corresponding to other information, such as updates to the PSI table 214, may be appropriately routed by the demultiplexer 220.

The descrambling engine 224 may use the control words output by the smart card 222 in order to descramble video and/or audio corresponding to television channels for storage and/or presentation. Video and/or audio data contained in the transponder data stream received by the tuners 204a-h may be scrambled. The video and/or audio may be descrambled by the descrambling engine 224 using a particular control word. Which control word output by the smart card 222 to be used for successful descrambling may be indicated by a scramble control identifier present within the data packet containing the scrambled video or audio. Descrambled video and/or audio may be output by the descrambling engine 224 to the storage medium 208 for storage, such as part of the DVR database 216 for example, and/or to the decoder 226 for output to a television or other presentation equipment via the television interface 212.

For brevity, the television receiver 102 is depicted in a simplified form, and may generally include more or fewer elements or components as desired, including those configured and/or arranged for implementing various features associated with intelligently allocating idle tuner resources to buffer or record broadcast programming determined as desirable, as discussed in the context of the present disclosure. For example, the television receiver 102 is shown in FIG. 2 to include the viewer status engine 110 as mentioned above in connection with FIG. 1. Further, some routing between the various modules of the television receiver 102 has been illustrated. Such illustrations are for exemplary purposes only. The state of two modules not being directly or indirectly connected does not indicate the modules cannot communicate. Rather, connections between modules of the television receiver 102 are intended only to indicate possible common data routing. It should be understood that the modules of the television receiver 102 may be combined into a fewer number of modules or divided into a greater number of modules.

Additionally, although not explicitly shown in FIG. 2, the television receiver 102 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Further, the television receiver 102 may be configured to include any number of other various components or logical modules that are implemented in hardware, software, firmware, or any combination thereof, and such components or logical modules may or may not be implementation-specific.

Still referring to FIG. 2, the viewer status engine 110 includes processor-readable instructions that, when executed by the one or more processors 202, provides for the various systems and methods described herein with regard to managing presentation of the media content, and/or managing, at least in part, operational settings of various devices or smart devices 112 in communication with the television receiver 102 as shown in FIG. 1. In an example implementation, the viewer status engine 110 instructs the processors 202 to output, e.g. play, the media content for display to the viewer through the display device 104 and receives status data that is detected by the status sensor 108 in communication with or integrated with the television receiver 102. It is contemplated that the term “status data” is used herein to refer to a non-constant data that may be continuously received and continuously changed depending on the detection of the viewer activity from the status sensor 108.

The viewer status engine 110 may analyze the status data to determine if the viewer is absent and/or present in the viewing environment, and/or if the viewer is busy in the environment, e.g., taking a phone call. Based on the determination of the viewer status, the viewer status engine 110 pauses and/or records the media content when the viewer is absent, and resumes playback of the media content and/or outputs the recorded content when the viewer returns. Further, the viewer status engine 110 can provide instructions for other functionalities, including sending and receiving settings to smart devices 112 in response to the detected status data. It is noted that although the viewer status engine 110 described herein is implemented in the television reciever 102, the engine 110 can be applicable for any computing device that presents any type of audio and/or visual media content and is not limited to the television systems.

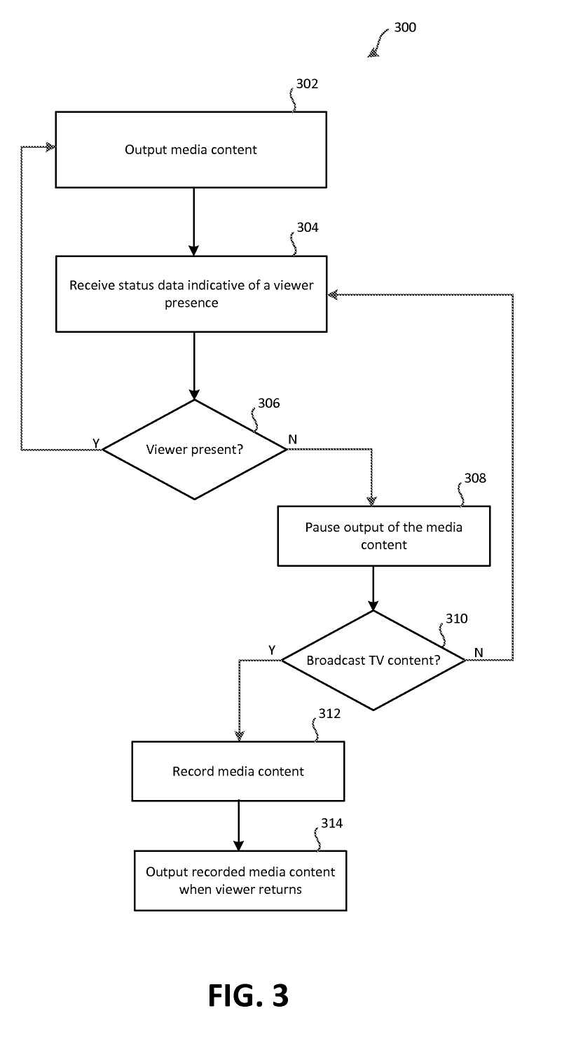

Turning now to FIG. 3, a method 300 for managing presentation of the media content that may be performed by the viewer status engine 110 is shown. The method 300 comprises the step of outputting 302 the media content through the display device 104 and receiving 304 status data from the status sensor 108. The method 300 further comprises determining 306, based on the status data, if the viewer is present in the environment containing the display device 104. If the viewer is determined to be present, the method returns to step 302 and continues to output the media content. If the viewer is determined to be absent, the method 300 comprises pausing 308 output of the media content through the display device 104. In some embodiments, the method 300 further comprises determining 310 if the media content comprises broadcast television media content, which may include one or more programming events, such as a scheduled show, and/or a commercial event being presented. If the media content is not broadcast television media content or other live content, e.g. the media content is a recording or DVD, the method 300 maintains pausing of the media content and returns to step 304 to continue monitoring the status data and check when the viewer returns. Once the viewer returns, the method 300 returns to step 302 and the media content is unpaused and output through the display device 104.

In another aspect, the method 300 may include a hysteresis or other momentary lag in recording and pausing the media content when the status sensor detects that the viewer has left the environment. For instance, the method 300 may include determining, based on the sensed data, that the viewer has left the environment, and upon determining that the viewer is absent, start recording the media content prior to, or without, pausing the media content until further status data is received from the sensor to confirm that the viewer has left the environment. For instance, the viewer status engine 110 may start recording the program upon receiving and/or determining that a first status data indicates the viewer has left the environment. The viewer status engine 110 may continue outputting the program through the display device 104 until a second status data, or a series of subsequent and/or consecutive status data, is received and indicative of the viewer's absence. At that point, the viewer's absence is confirmed and the media content may be paused by the viewer status engine 110. Subsequently, upon the viewer's return, the media content may be unpaused and output starting from the first point in which the recording was initiated. Merely by way of example, the lag between recording and pausing the media content when the viewer is confirmed to be absent may be a fraction of a second, one second, or 1-2 seconds. It is contemplated that a benefit of the momentary lag is that the system may be more independent of the status sensor's sensitivity. Other examples are possible. For instance, the pausing and recording steps may be initiated more simultaneously. Furthermore, in some aspects, the method 300 may include recording, or initiating recording, during a commercial event.

Still referring to FIG. 3, in another aspect, at step 310, the media content is determined to include the broadcast television media content. In some embodiments, it is contemplated that the method 300 maintains pausing of the output of media content and records 312 the media content, such as the incoming stream of media content being received by the television receiver 102. It is contemplated that the viewer status engine 110 continues receiving the status data and analyzing the status data to determine the viewer presence. Once the viewer is determined to be present, i.e. has returned to the environment, the method 300 continues to step 314 and the recorded media content is output for presentation.

In one aspect, the viewer status engine 110 may provide an option for the viewer to resume playback of the recorded portions at a higher speed, for instance a playback speed that is slightly quicker than real time. In some cases, the higher speed may be determined or based on a speed needed to allow the playback to catch up with live television by the time the program has ended. Merely by way of example, the higher speed may be 1.1× speed with audio pitch correction may be provided. It is contemplated that this higher speed may be almost imperceptible to most viewers. In another example, the higher speed may be about 1.2×, or 1.2 times faster than the real time speed. In yet another example, a pre-set value may define a threshold value that cannot be exceeded, such as 1.2×. The pre-set value may be any speed higher than the real time speed that is not noticeably different from real time by the viewer. In a further aspect, the viewer status engine 110 may calculate or otherwise determine a minimum playback speed that is needed in order to catch up with live television. For instance, the minimum playback speed may be based on the remaining time length of the particular program being aired and a time length of the recorded buffer. The viewer status engine 110 may implement the minimum playback speed following unpausing of the media content, or may implement a faster speed that is still less than the pre-set value and/or within the imperceptible range. In a different example, the higher speed may be 2×, or a noticeably higher speed or fast forward option with pausing capabilities, to allow the user to view portions of interest in the missed content and to skip less interesting recorded portions, until the viewer is caught up with the live broadcast television. It is contemplated that such capabilities may be beneficial for the viewer's convenience, for instance in preventing the automatically paused program from delaying the viewer's evening or running into later broadcast times of other programs that the viewer intends watch. Other examples are possible.

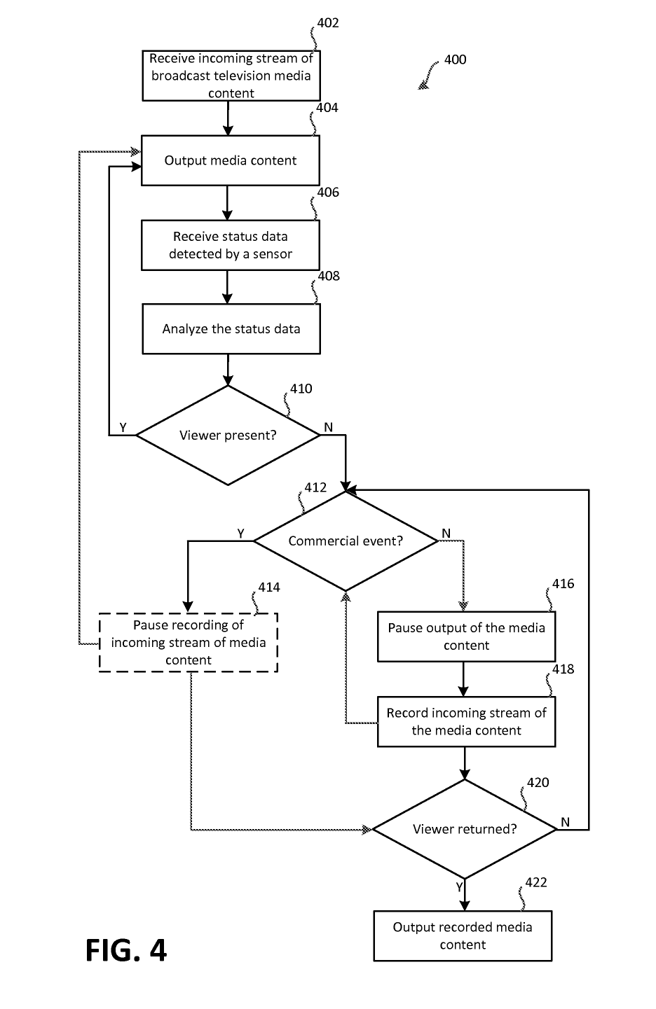

Referring now to FIG. 4, another method 400 for managing presentation of the media content that may be performed by the viewer status engine 110 is shown. The method 400 may include, additionally or alternatively, any of the steps presented in FIG. 3. In one aspect, the method includes receiving 402 an incoming stream of the broadcast television media content, whereby the broadcast television media content includes the programming event and/or the commercial event. The method 400 further comprises outputting 404 the broadcast television media content for presentation and receiving 406 status data detected by the status sensor 108. In some embodiments, the method 400 comprises analyzing 408 a first status data detected by the status sensor 108 and determining 410 that the viewer is present in the environment containing the display device 104 based on the first status data. As shown in FIG. 4, if the viewer is present, the method 400 returns to step 404 to continue output of the media content.

In some cases, the method 400 comprises determining 412, before, after, and/or in response to determining that the viewer is present in the environment, that the viewer has left the environment based on a second status data detected by the status sensor. The method 400 may then comprise determining 412 if the viewer left the environment during a commercial break by detecting a commercial event. More particularly, the viewer status engine 110 may detect a beginning or an end tag of a commercial event in an incoming stream of the broadcast television media content to determine occurrence of the commercial event. Alternatively and/or additionally, the viewer status engine 110 may retrieve and/or receive information indicative of a start or end time of a commercial event, or whether the current programming content is a commercial, from another source. In that case, the viewer status engine 110 determines that the viewer left during a commercial and may return to step 404 to continue output of the commercial event rather than pausing the commercial.

In other embodiments, the method 400 comprises pausing 414 a recording of the media content (if recording was previously initiated) when the commercial event is detected and resuming recording after the commercial event has ended, and/or in response to determining that the commercial event has ended. For instance, if the viewer status engine 110 detects an end, such as the end tag, of the commercial event before determining that the viewer has returned to the environment based on the status data detected by the status sensor 108, the viewer status engine 110 may pause output of the media content and record the media content. More particularly, the viewer status engine 110 may record an incoming stream of the media content from the content provider 106, without playing the content on the display device 104 and/or providing a frozen frame taken from the paused content. In a particular aspect, the recorded media content may be saved on the television receiver 102 or an external memory drive (not shown) connected thereto. The recorded media content may be stored in the storage medium 208 of FIG. 2. It is contemplated that the recording may continue through the end of a particular programming event in the media content, such as automatically stop recording at an end of the scheduled show, until a storage memory is filled to capacity, and/or for a predetermined or user-defined storage capacity or recording time, such as three hours. The recording may also terminate based on a user input in the television receiver 102 to stop the recording. It is noted that step 414 is an optional step in the method 400. Further, it is noted that any of the steps provided herein and shown in FIG. 4 may be optional.

At a later point after the recording has begun, the viewer status engine 110 may determine 420, based on the status data, that the viewer has returned to the environment containing the display device 104 and output 422 the recorded media content for presentation through the display device 104.

In another embodiment, the method 400 at step 412 does not detect the commercial event. In this case, it is contemplated that a programming event having viewer-desired content is being provided. With the viewer being absent from the environment, the method 400 continues to pause 416 the output of the media content through the display device 104 and record 418 the incoming stream of the media content, such as the broadcast television media content being streamed from the content provider 106 to the television receiver 102. The method 400 further comprises determining 420 if the viewer has returned to the environment. If the viewer has returned, the method 400 outputs 422 the recorded media content for display to the user. If the viewer has not yet returned, the method 400 continues to detect for commercial events at step 412 to pause or unpause the recording until the viewer has returned.

Still further, it is contemplated that the method 400 may include initiating a sleep mode that causes the display device to turn off or enter standby while the viewer is absent from the environment for a period of time that can be set by the viewer. In another aspect, the method 400 may include receiving wireless status data detected by the status sensor that is indicative of a presence of a mobile device in the environment containing the display device. The wireless status data may further indicate if the mobile device is being used, e.g. the person has received and/or answered a phone call, in which case the method 400 may determine that the viewer is not present. The method may include analyzing the wireless status data to determine the presence of the viewer in the environment containing the display device.

Still, in other aspects, the method may utilize a home automation system that is linked to the television receiver 102 and/or the viewer status engine 110. For instance, the method 400 may include the steps of sending a first operational setting to the smart device 112 in communication with the television receiver 102 after and/or in response to determining that the viewer has left the environment, and sending a second operational setting to the smart device 112 after and/or in response to determining that the viewer has returned to the environment containing the display device. It is contemplated that the first and second operational settings are different settings to control a power level and/or other operation of the smart device 112 located in the environment containing the display device 104. For example, the smart device 112 may comprise a lighting device located in the environment, the first operational setting may include powering down, e.g. dimming, and/or off of the lighting device upon detection that the viewer is absent for a period of time that can be set by the user, and the second operational setting may include powering up or resuming an original state of the lighting device after and/or in response to determining that the viewer has returned to the environment. In a different example, the first operational setting may comprise turning down or off the smart device 112, e.g. a dishwashing cycle of a dishwasher when the viewer is present, and the second operational setting may comprise turning on the smart device 112, e.g. resuming wash of the dishwasher when the viewer is absent, which eliminates noise disturbances during the viewer's viewing of the show if the smart device 112 is in the environment of the display device 104, or in proximity thereto.

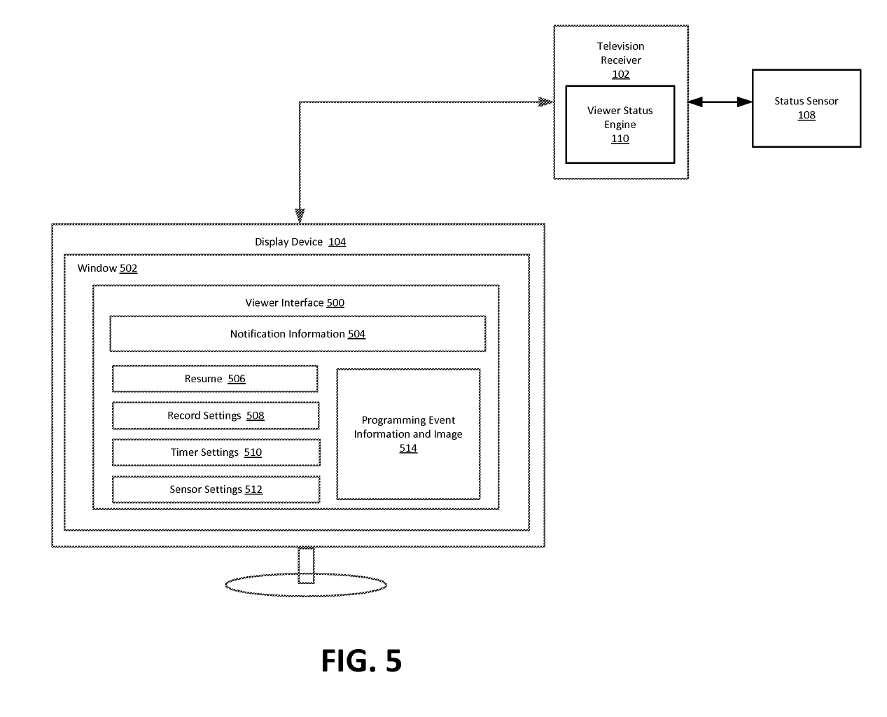

In further aspects, it is contemplated that the method 400 includes presenting a user interface overlay and/or menu on the screen of the display device 104, such as the interface 500 illustrated below in FIG. 5. In particular, the user interface 500 may be presented if the media content is paused. In one aspect, the method 400 includes presenting an option for the viewer to resume output of the media content after pausing the media content and/or setting a duration of time for recording the media content. Even further, the method may include the step of outputting, after and/or in response to pausing output of the media content, a message indicating a reason for pausing the output. It is contemplated that the message may comprise a textual notification, a sound notification, and/or a graphical notification presented via the display device 104 or incorporated in the user interface. Such notifications may further include information regarding operational changes to smart devices 112.

Referring now to FIG. 5, an example user interface 500 is shown on a window 502 of the display device 104. Optionally, the user interface 500 or various elements thereof may be pushed, by the viewer status engine 110, to the viewer's portable device, e.g. an app on a smart phone. The user interface 500 may be provided for by the viewer status engine 110 of the television receiver 102 and appear in the window 502 when the viewer is determined to be absent. However, it is also noted that the user interface 500 may appear while the viewer is determined to be present. For instance, the user interface 500 may be provided upon request by the viewer. The user interface 500 may be a graphical user interface having a menu and configured to receive user input. For instance, the user interface 500 may include a notification information 504 indicating a reason for the paused content and/or if the content is being recorded. Merely by way of example, the notification information 504 may include text stating, “Content paused and being recorded due to viewer absence.” In a different aspect, the notification information 504 may be provided in an audio format that may be heard by the viewer when located in a different environment away from the display device 104. Still further, the notification information 504 may contain information regarding a smart device 112. For instance, the notification may state, “Lights dimmed; content paused and being recorded due to viewer absence.” Furthermore, any of the components described herein may display a timer showing a duration of time that the media content has been paused and/or recorded, and/or a length of time related to how long the recorded media content minus the commercial events is.

Still referring to FIG. 5, in addition to the notification information 504, in some embodiments, the user interface 500 may include one or more buttons for the viewer to select, via voice recognition, touch screen, and/or a remote control, to resume 506 output of the media content. A benefit of this feature may include un-pausing the programming event if the viewer chooses to listen to the media content while being absent from the environment. In another aspect, the user interface 500 may include a record settings 508 option to allow the viewer to input recording options, such as a recording time, recording duration, a memory size allocated for saving the recording, and desirable or undesirable content for recording. For instance, the record settings 508 may permit the viewer to input one or more undesirable events that should not be recorded, and/or should not be paused. Such undesirable events may include particular commercial events, programming events, production credit events, and previews events. The viewer status engine 110 may identify such events by event tags in the media content and/or by identifying programmed air times for such events to pause and/or record the events based on the viewer's selection. To receive various viewer inputs, the record settings 508 button may open one or more additional interfaces and/or menus designed to receive the viewer selections. Further, any of the components of the user interface 500 described herein may link to additional interfaces. In another aspect, any of the buttons described herein may be operated through other devices, including other computing devices, mobile phones, tablets, and the like.

Still in reference to FIG. 5, the user interface 500 may include a timer settings 510 option to receive viewer input related to timing of various functions offered by the viewer status engine 110. In one embodiment, the timer settings 510 receives viewer input for a duration of time for keeping the display device 104 and/or the television receiver 102 paused until either device 104, 102 is automatically turned off or placed in standby mode. Merely by way of example, the duration of time may be between about 1.5 hours to about 5 hours. In a different aspect, the timer settings 510 may receive user input on when to notify one or more smart devices 112. For instance, the timer settings 510 may receive user input for a wait period before dimming lights after and/or in response to detecting the viewer's absence and/or displaying a screensaver in the window 502. Merely by way of example, the wait period may be between about 5 to 10 minutes. Additionally and/or alternatively, the viewer status engine 110 may use an HDMI CEC to power off the display screen sometime after initiating the screensaver to save power. In a further aspect, the timer settings 510 may receive input regarding a pause period, whereby the viewer status engine 110 detects that the viewer is absent, pauses the media content, and initiates the pause period prior to initiating recording of the media content, so that the viewer status engine 110 does not initiate recording immediately after and/or immediately in response to determining that the viewer is absent. Merely by way of example, the pause period may be about 10 seconds to about 2 minutes, or any other time selected by the viewer.

Referring yet again to FIG. 5, the user interface 500 may include a sensor settings 512 option. For instance, the sensor settings 512 may be configured to receive viewer input on a time of day and/or duration for the status sensor 108 and/or the viewer status engine 110 to be active and operate. Merely by way of example, sensor settings may permit the viewer to set a detection period and/or sensitivity. For instance, the status sensor 108 may be detect a viewer absence, presence, and busy status during daytime hours between 6 AM to 9 PM. In another aspect, the status sensor 108 may detect for viewer movement and determine if the viewer is asleep to pause and/or record the show, such as during afternoon and/or nighttime hours. In another aspect, the sensor settings 512 may indicate a type of sensed data to detect, such as a wireless signal during the daytime, and viewer movement during the nighttime, particularly if a variety of different status sensors 108 are provided in communication with the viewer status engine 110. In other aspects, detection may still occur but the detected status data may not be registered by the viewer status engine 110. Still, in further aspects, the status sensors 108 may be in different environments and the sensor settings 512 may be configured to store and operate settings for each status sensor 108.

Still, in regard to the sensor settings 512, the viewer may select to turn the voice notification information on or off. In a different aspect, the viewer status engine 110 may store several viewer preferences and lists of undesirable and/or desirable contents for a unique viewer under a viewer profile. In the sensor settings 512, the viewer may indicate which viewer from a plurality of viewer profiles to identify and activate in the viewer status engine 110. For instance, if the status sensor 108 is a camera, the viewer may select which facial features to detect for determining the viewer status and management of the media content. In this way, the viewer status engine 110 manages output of the media content based on a particular viewer even if multiple viewers are in the environment.

Further shown in FIG. 5, the user interface 500 may include programming event information and/or images 514, and/or advertisements. The programming information 514 may provide information about the particular media content being paused, such as a currently programmed time slot, future air times and channels, casting information, production date, links to external webpages to order the show or find more information about it, trailers, and the like. Furthermore, the programming event 514 may include dynamically changing images and/or information rather than a still image or text. Even further, the programming information 514 may also show advertisements for other shows and/or paid advertisements from third party companies. It is contemplated that the user interface 500 may include any combination of the components introduced above on the window 502 of the display device 104 or on any other device in wireless or hardwired communication with the viewer status engine 110. For instance, the user interface 500 options may be provided through an mobile phone application, which may alert the viewer's mobile phone on when the media content is paused, recorded, and/or when the connected devices are operationally altered due to the sensed viewer status.

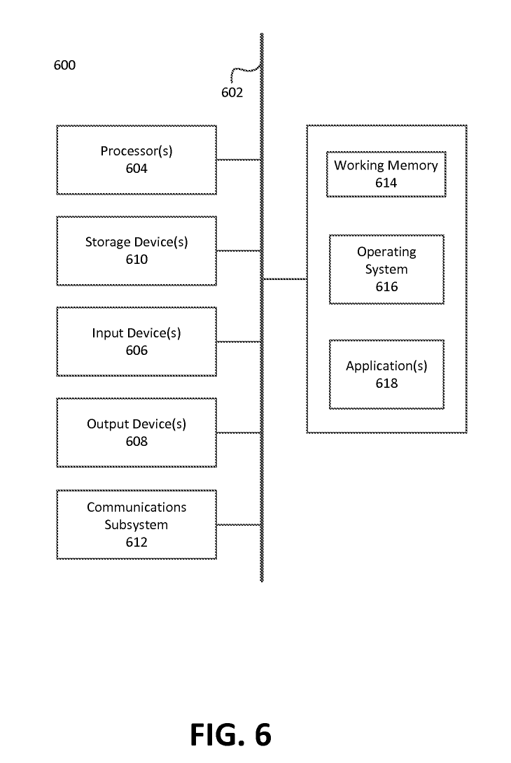

FIG. 6 shows an example computer system or device 600 in accordance with the disclosure. An example of a computer system or device includes an enterprise server, blade server, desktop computer, laptop computer, tablet computer, personal data assistant, smartphone, gaming console, STB, television receiver, and/or any other type of machine configured for performing calculations. Any particular one of the previously-described computing devices may be wholly or at least partially configured to exhibit features similar to the computer system 600, such as any of the respective elements of at least FIGS. 1 and 2. In this manner, any of one or more of the respective elements of at least FIGS. 1 and 2 may be configured to perform and/or include instructions that, when executed, perform the method of FIG. 3 and/or the method of FIG. 4. Still further, any of one or more of the respective elements of at least FIGS. 1 and 2 may be configured to perform and/or include instructions that, when executed, instantiate and implement functionality of the television receiver 102 and/or the server(s).

The computer device 600 is shown comprising hardware elements that may be electrically coupled via a bus 602 (or may otherwise be in communication, as appropriate). The hardware elements may include a processing unit with one or more processors 604, including without limitation one or more general-purpose processors and/or one or more special-purpose processors (such as digital signal processing chips, graphics acceleration processors, and/or the like); one or more input devices 606, which may include without limitation a remote control, a mouse, a keyboard, and/or the like; and one or more output devices 608, which may include without limitation a presentation device (e.g., television), a printer, and/or the like.

The computer system 600 may further include (and/or be in communication with) one or more non-transitory storage devices 610, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 600 might also include a communications subsystem 612, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 612 may permit data to be exchanged with a network (such as the network described below, to name one example), other computer systems, and/or any other devices described herein. In many embodiments, the computer system 600 will further comprise a working memory 614, which may include a random access memory and/or a read-only memory device, as described above.

The computer device 600 also may comprise software elements, shown as being currently located within the working memory 614, including an operating system 616, device drivers, executable libraries, and/or other code, such as one or more application programs 618, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 610 described above. In some cases, the storage medium might be incorporated within a computer system, such as computer system 600. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer device 600) to perform methods in accordance with various embodiments of the disclosure. According to a set of embodiments, some or all of the procedures of such methods are performed by the computer system 600 in response to processor 604 executing one or more sequences of one or more instructions (which might be incorporated into the operating system 616 and/or other code, such as an application program 618) contained in the working memory 614. Such instructions may be read into the working memory 614 from another computer-readable medium, such as one or more of the storage device(s) 610. Merely by way of example, execution of the sequences of instructions contained in the working memory 614 may cause the processor(s) 604 to perform one or more procedures of the methods described herein.

The terms “machine-readable medium” and “computer-readable medium,” as used herein, may refer to any non-transitory medium that participates in providing data that causes a machine to operate in a specific fashion. In an embodiment implemented using the computer device 600, various computer-readable media might be involved in providing instructions/code to processor(s) 604 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 610. Volatile media may include, without limitation, dynamic memory, such as the working memory 614.

Example forms of physical and/or tangible computer-readable media may include a floppy disk, a flexible disk, hard disk, magnetic tape, or any other magnetic medium, a compact disc, any other optical medium, ROM, RAM, and etc., any other memory chip or cartridge, or any other medium from which a computer may read instructions and/or code. Various forms of computer-readable media may be involved in carrying one or more sequences of one or more instructions to the processor(s) 604 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 612 (and/or components thereof) generally will receive signals, and the bus 602 then might carry the signals (and/or the data, instructions, etc. carried by the signals) to the working memory 614, from which the processor(s) 604 retrieves and executes the instructions. The instructions received by the working memory 614 may optionally be stored on a non-transitory storage device 610 either before or after execution by the processor(s) 604.

It should further be understood that the components of computer device 600 can be distributed across a network. For example, some processing may be performed in one location using a first processor while other processing may be performed by another processor remote from the first processor. Other components of computer system 600 may be similarly distributed. As such, computer device 600 may be interpreted as a distributed computing system that performs processing in multiple locations. In some instances, computer system 600 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for pausing output of a media content based on a viewer status, comprising:
outputting, by a television receiver, the media content for presentation via a display device;
receiving, by the television receiver, status data detected by a status sensor, wherein the status data is indicative of a presence of a viewer in an environment containing the display device;
determining, by the television receiver, that the viewer is present in the environment based on the status data;
receiving, by the television receiver, updated status data detected by the status sensor;
determining, by the television receiver, that the viewer has left the environment based on the updated status data detected by the status sensor; and
in response to determining that the viewer has left the environment, pausing, by the television receiver, output of the media content via the display device.

2. The method of claim 1, further comprising:
determining, by the television receiver, that the viewer has returned to the environment; and
after determining that the viewer has returned, resuming output, by the television receiver, of the media content via the display device.

3. The method of claim 1, further comprising:
determining, by the television receiver after determining that the viewer has left the environment, that the media content includes broadcast television media content; and
recording, by the television receiver after determining that the media content includes broadcast television media content, the media content.

4. The method of claim 3, further comprising pausing recording, by the television receiver, during a commercial event that is included in the media content.

5. The method of claim 3, further comprising:
determining, by the television receiver after initiating recording, that the viewer has returned to the environment based on the status data detected by the status sensor; and
after determining that the viewer has returned to the environment, outputting, by the television receiver, the recorded media content for presentation via the display device.

6. The method of claim 1, further comprising outputting, by the television receiver after pausing output of the media content, a message indicating a reason for pausing the output, wherein the message comprises at least one of a textual notification, a sound notification, and a graphical notification presented via the display device.

7. The method of claim 1, further comprising presenting, by the television receiver, a user interface menu that includes at least one of resuming output of the media content after pausing the media content and setting a duration of time for recording the media content.

8. The method of claim 1, further comprising initiating, by the television receiver after pausing output of the media content, a sleep mode that causes the display device to turn off or enter standby.

9. The method of claim 1, further comprising sending, by the television receiver after determining that the viewer has left the environment containing the display device, a first operational setting to a smart device in communication with the television receiver.

10. The method of claim 9, further comprising sending, by the television receiver after determining that the viewer has returned to the environment containing the display device, a second operational setting to the smart device, wherein the second operational setting is different than the first operational setting.

11. The method of claim 10, further wherein:
the smart device is a lighting device located in the environment containing the display device;
the first operational setting includes at least one of powering down or off of the lighting device; and
the second operational setting includes at least one of powering up or resuming an original state of the lighting device.

12. The method of claim 1, further comprising:
receiving, by the television receiver, status data detected by the status sensor that is indicative of a presence of a mobile device in the environment containing the display device; and
analyzing, by the television receiver, the status data that is indicative of the presence of the mobile device to determine the presence of the viewer in the environment containing the display device.

13. A television receiver for managing presentation of media content based on a viewer status, comprising:
one or more processors; and
a memory communicatively coupled with and readable by the one or more processors and having stored therein processor-readable instructions that, when executed by the one or more processors, cause the one or more processors to:
output the media content for presentation via a display device;
receive status data detected by a status sensor, wherein the status data is indicative of a presence of a viewer in an environment containing the displace device;
determine that the viewer is present in the environment based on the status data;
receive, by the television receiver, updated status data detected by the status sensor;
determine that the viewer has left the environment based on the updated status data; and
in response to determining that the viewer has left the environment, pause output of the media content via the display device.

14. The television receiver of claim 13, wherein the memory further includes processor-readable instructions stored therein that, when executed by the one or more processors, cause the one or more processors to:
determine that the viewer left the environment containing the display device during a commercial event included in the media content;
after determining that the viewer left the environment during the commercial event, continue output of the commercial event for presentation via the display device;
detect an end of the commercial event before determining that the viewer has returned to the environment based on the status data detected by the status sensor;
after detecting the end of the commercial event, pause output of the media content; and
record the media content.

15. The television receiver of claim 14, wherein the memory further includes processor-readable instructions stored therein that, when executed by the one or more processors, cause the one or more processors to:
determine that the viewer returned to the environment containing the display device; and
output the recorded media content for presentation via the display device.

16. A method for pausing playback of a broadcast television media content based on a viewer status, comprising:
receiving, by a television receiver, an incoming stream of the broadcast television media content, wherein the broadcast television media content includes a programming event;
outputting, by the television receiver, the broadcast television media content for presentation via a display device;
analyzing, by the television receiver, a first status data detected by a status sensor that senses a presence of a viewer in an environment containing the display device;
determining, by the television receiver, that the viewer is present in the environment based on the first status data;
determining, by the television receiver, that the viewer has left the environment based on a second status data detected by the status sensor;
in response to determining that the viewer has left the environment, pausing, by the television receiver, output of the programming event in the broadcast television media content; and
in response to pausing output of the programming event, recording, by the television receiver, the incoming stream of the programming event in the broadcast television media content.

17. The method of claim 16, further comprising:
after determining that the viewer has returned to the environment based on a third status data detected by the status sensor, outputting, by the television receiver, the recorded programming event.

18. The method of claim 17, further comprising:
detecting, by the television receiver, a commercial event in the broadcast television media content; and
pausing, by the television receiver, recording of the incoming stream of the broadcast television media content until the commercial event has ended.

19. The method of claim 18, further comprising:
outputting, by the television receiver, the commercial event for presentation via the display device;
after outputting the commercial event, detecting, by the television receiver, at least one of an end of the commercial event and a beginning of the programming event;
after detecting at least one of the end of the commercial event and the beginning of the programming event, pausing, by the television receiver, output of the programming event; and
after pausing output of the programming event, recording, by the television receiver, the incoming stream of the programming event.

20. The method of claim 16, further comprising recording, by the television receiver, for a duration of time through an end of the programming event.
